(19) United States
(12) Patent Application Publication
(10) Pub. No.: US 2006/0291888 A1
(43) Pub. Date: Dec. 28, 2006

(54) User interface and computer readable medium storing computer program

(76) Inventors: Yoshio Miyamoto, Tokyo (JP); Tamotsu Sakuraba, Tokyo (JP); Michio Osada, Tokyo (JP)

Correspondence Address: CANTOR COLBURN, LLP, 55 GRIFFIN ROAD SOUTH, BLOOMFIELD, CT, 06002, US

(21) Appl. No.: 11/237,432

(22) Filed: Sep. 28, 2005

(30) Foreign Application Priority Data
Jun. 28, 2005 (JP) 2005-188145

(51) Int. Cl. G03G 15/00

(52) U.S. Cl. 399/81; 399/82

(57) ABSTRACT

Disclosed is a user interface to carry out a book printing in which one sheet is associated with a plurality of pages of a book, wherein the user interface is capable of setting different print modes for the sheets constituting the book.

### BACKGROUND OF THE INVENTION

1. Field of the Invention

The present invention relates to a user interface and a computer readable medium storing a computer program for print setting.

2. Description of Related Art

So far, book printing has been performed in a printer, MFP (multi function peripheral) and the like, in which documents are printed to a plurality of sheets to form a book. For example, JP 2002-244493A (hereinafter referred to as patent document 1) discloses that different print mode can be set for a cover sheet from that for the other sheet in book printing.

However, in the technique disclosed in patent document 1, only one identical print mode is applied to all sheets other than a cover sheet. Thus, when a special sheet different from the other sheets (for example, a sheet of different paper type, M weight or paper color) is used for a certain sheet other than a cover sheets it has been necessary to print whole sheets of a book firstly and to substitute a certain sheet with the separately printed special sheet. Thus, it has been problematic that book making process takes a lot of trouble and has low processing efficiency.

### SUMMARY OF THE INVENTION

The present invention was achieved with consideration of the above circumstances. One of the objects of the present invention is to make it possible to set a print mode on a per-sheet basis.

In order to achieve at least one of the above mentioned objects, according to one embodiment reflecting the first aspect of the invention, a user interface is to carry out a book printing in which one sheet is associated with a plurality of pages of a book, the user interface being capable of setting different print modes for the sheets constituting the book.

Herein, the print mode is typically to specify a sheet. For example, a paper size, a paper feed tray, a paper type (plain paper, board paper and the like), an M weight, a paper color and the like can be given.

Preferably, a display section displays a plurality of page numbers corresponding to pages that are laid out to a same sheet to which at least one of the print modes has been set.

Preferably, each of the print modes is settable on a per-page basis.

In the print mode on a per-page basis, the set print mode is preferably applied to whole of the sheet, when the print mode is set to any one page of a plurality of pages laid out to the sheet.

In setting the print mode on a per-page basis, the display section preferably displays a warning screen, when different print modes are set to two or more different pages of a plurality of pages that are to be laid out to one sheet.

In setting the print mode on a per-page basis, when a print mode is set to a page, a display section preferably displays a sheet number of the sheet to which the page is laid out.

Preferably, the user interface sets the different print modes for the sheets constituting the book if one print job is to print on at least two sheets.

In order to achieve at least one of the above mentioned objects, according to one embodiment reflecting the second aspect of the invention, a computer executable program is to carry out a book printing in which one sheet is associated with a plurality of pages of a book, wherein the computer executable program provide a user with a user interface capable of setting different print modes for the sheets constituting the book.

Preferably, the computer executable program is to display on a display section a plurality of page numbers corresponding to pages that are laid out to a same sheet to which at least one of the print modes has been set.

Preferably, the computer executable program is to set each of the print modes on a per-page basis.

In setting the print mode on a per-page basis, the set print mode is preferably applied to whole of the sheet, when the print mode is set to any one page of a plurality of pages laid out to the sheet.

In setting the print mode on a per-page basis, the display section preferably displays a warning screen, when different print modes are set to two or more different pages of a plurality of pages that are to be laid out to one sheet.

In setting the print mode on a per-page basis, when a print mode is set to a page, a display section preferably displays a sheet number of the sheet to which the page is laid out.

Preferably, the different print modes for the sheets constituting the book if one print job is to print on at least two sheets.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a view showing a constitution of a print system of the embodiment of the invention;

FIG. 2 is a block diagram showing a main structure of a PC and printer constituting the print system;

FIG. 3 is a flowchart showing a print setting process executed in the print system;

FIG. 4 is a view showing a whole setting screen displayed on a display section of the PC;

FIG. 5 is a view showing a per-sheet basis setting list screen displayed on the display section of the PC;

FIG. 6 is a view showing a list name displayed on a list name item;

FIG. 7 is a view showing a per-sheet basis setting screen displayed on the display section of the PC;

FIG. 8 is a view showing the sheet setting screen where a print mode is set only by designation of sheet number;

FIG. 9 is a view showing the sheet setting list screen where a print mode is set only by designation of sheet number;

FIG. 10 is a view showing the sheet setting screen where a print mode is set only by designation of page number;

FIG. 11 is a view showing the sheet setting list screen where a print mode is set only by designation of page number;

FIG. 12 is a view showing a warning message displayed on the display section of the PC.

### DETAILED DESCRIPTION OF THE PREFERRED EMBODIMENT

Hereinafter, an embodiment of the present invention will be described with reference to the drawings.

First, a constitution of the embodiment will be described.

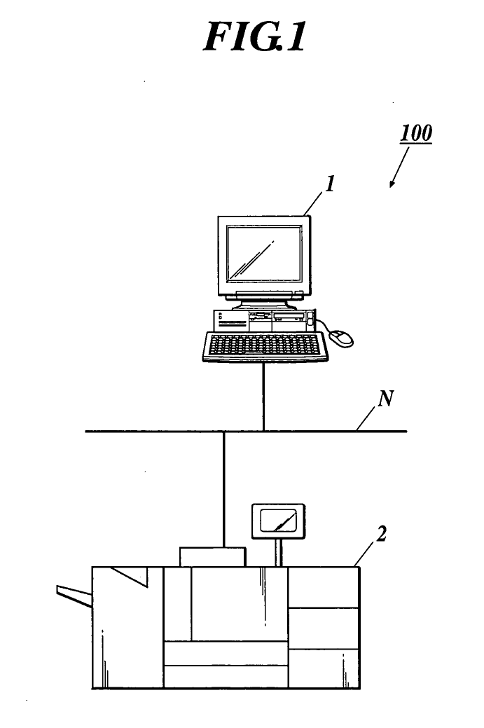

FIG. 1 is a whole constitution of a print system 100 of the present embodiment. As show in FIG. 1, the print system 100 comprises a PC (personal computer) 1 and a printer 2 which are connected with each other through a communication network N so as to be communicated with each other.

The communication network N is composed of a LAN (local area network) in which a computer and network equipments are connected with each other by a standard such as ETHERNET®, token ring, FDDI (fiber distributed data interface) and the like, a WAN (wide area network) in which LANs are connected with each other through a leased line, or the like.

Instead of the printer 2, an image forming apparatus can be used, such as an MFP (multi function peripheral) comprising a plurality of functions such as a copier, scanner and printer altogether. Further, the number of the PC 1 or printer 2 constituting the print system 100 is not especially limited. In the present embodiment, a booklet printing is explained as an example, however it is not limited thereto. Hereinafter in the present embodiment, a paper output as a result of printing of the printer 2 is referred to as a “sheet”.

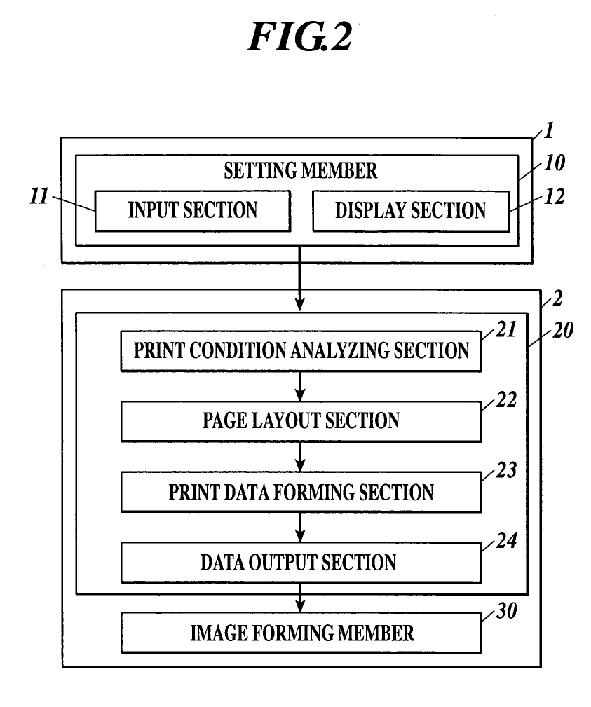

FIG. 2 shows a main structure of the PC 1 and printer 2. PC 1 mounts a printer driver which is software to control a printer, and comprises an input section 10 and display section 12 as a setting member to set a print mode. PC 1 sends the print mode set with the setting member 10 to the printer 2. In the present embodiment, the print mode comprises paper size, feeder tray, paper type (plain paper, board paper or the like), M weight, paper color and the like, and does not limited thereto.

The input section comprises a keyboard, mouse and the like to input various orders. The display section 12 comprises a display such as an LCD (liquid crystal display).

When a book in which one sheet is composed of a plurality of pages is printed (book printing), a print mode is set on a per-sheet basis or on a per-page basis which constitute the book by controlling the input section 11. When the print mode is set on a per-sheet basis, the display section 12 displays a plurality of page numbers whose pages are arranged to the sheet where the print mode has been set.

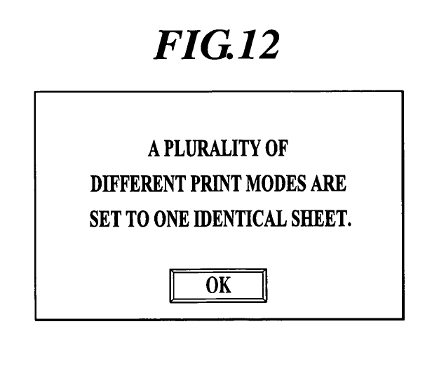

When the print mode is set to any one page of the plurality of pages arranged to one sheet, the set print mode is applied to the whole sheet. Further, two or more print modes are set to different pages among the pages arranged to one sheet, the display section 12 displays a warning screen (see FIG. 12). Further, when a print mode is set page by page, the display section 12 displays a sheet number of a sheet to which the set page is arranged. The above-described setting of the print mode is applied when one print job prints two or more sheets.

The printer 2 comprises a plurality of paper feed tray (not shown), papers having different size, type (plain paper, board paper or the like), M weight, paper color or the like can be housed by the feed tray. Further, the printer 2 comprises a print controller 20 and an image forming member 30 as shown in FIG. 2.

The print controller 20 comprises a print condition analyzing section 21, page layout section 22, print data forming section 23 and data output section 24.

The print condition analyzing section 21 analyzes a print condition from data sent from the PC 1. The page layout section 22 lays out the pages so that an output results a booklet. The print data forming section 23 forms data which is printed to each sheet (print data). The data output section 24 set the print data and print mode to each seat, and outputs it to the image forming member 30.

The image forming member 30 performs a print process according to the print mode and print data to the designated paper by a predetermined method (for example, a laser beam method).

In the present embodiment, the printer 2 comprises the print controller 20. However, function of the print controller 20 can be included in a print controller separated from the printer 2, or the print driver.

Next, operation of the present embodiment will be described.

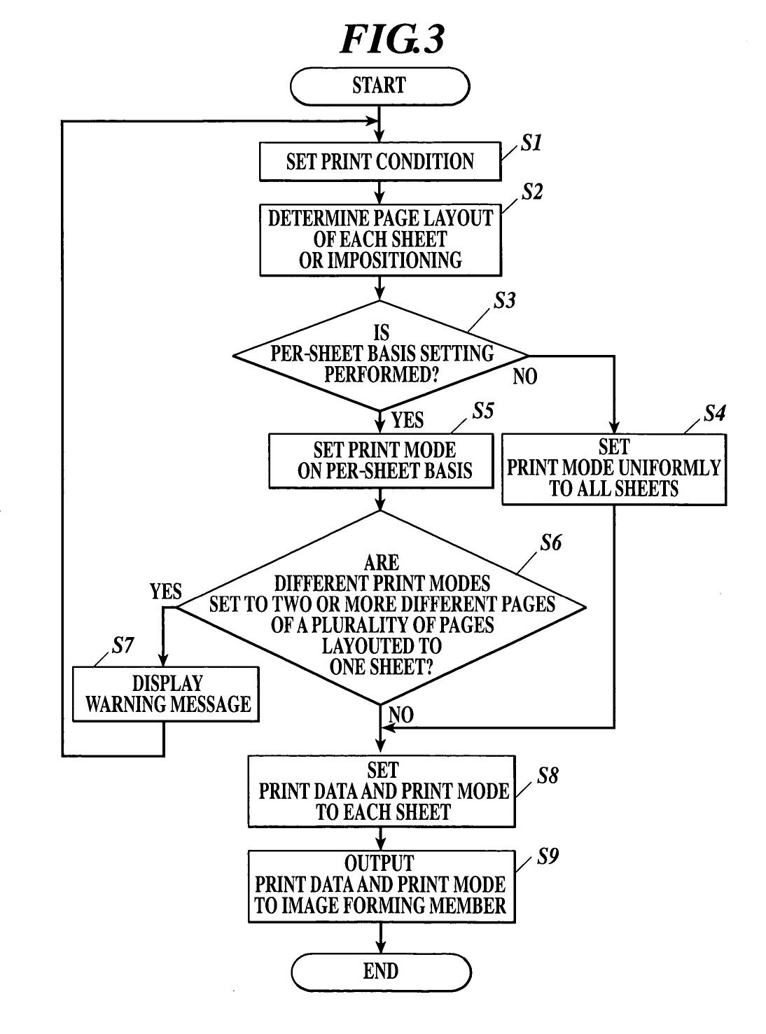

First, a print setting process executed in the print system 100 will be described with reference to the flowchart of FIG. 3.

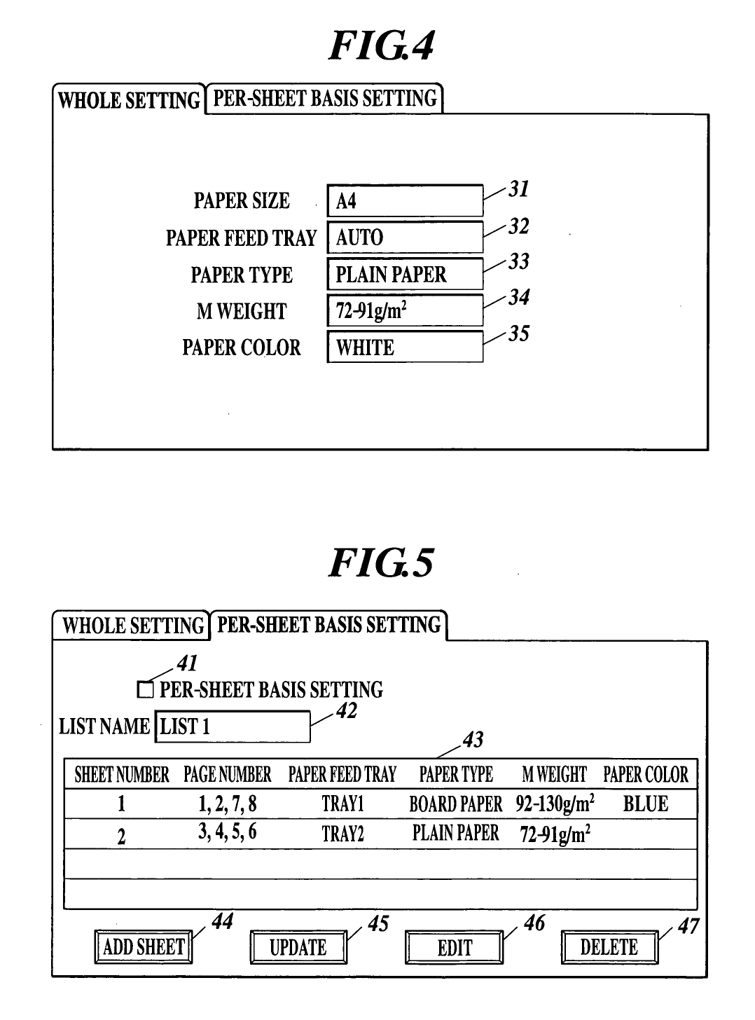

First, a setting member 10 of the PC 1 sets the print condition (step S1). In step S1, the display section 12 displays the whole setting screen as shown in FIG. 4 firstly. The whole setting screen is to set the print mode of a whole document (all sheets). As shown in FIG. 4, a paper size setting section 31, a paper feed tray setting section 32, a paper type setting section 33, an M weight setting section 34 and a paper color setting section 35 are arranged therein. The print mode is set by inputting necessary information to the respective setting sections of the whole setting screen with the input section 11.

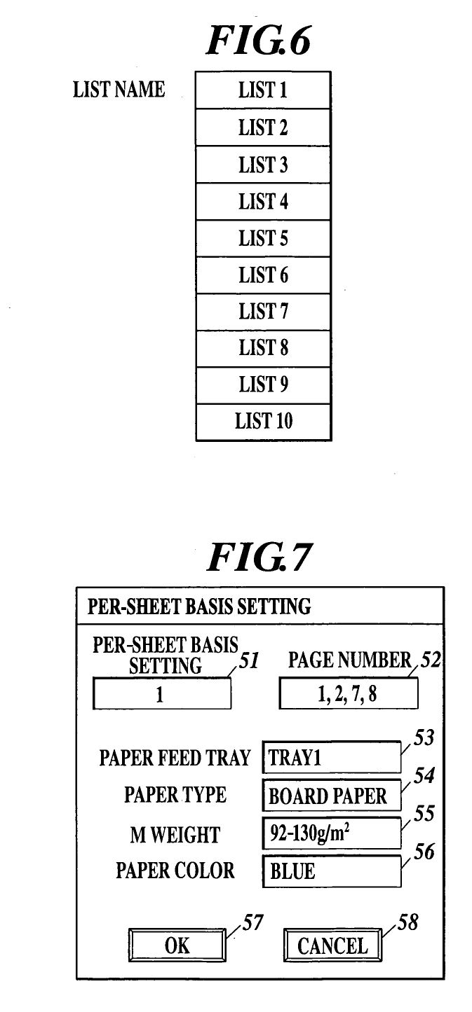

When a “per-sheet basis setting” item in the whole setting screen in FIG. 4 is designated with the input section 11, the display section 12 displays the per-sheet basis setting list screen as shown in FIG. 5. The per-sheet basis setting list screen is to display a list of the print mode which has set on a per-sheet basis. As shown in FIG. 5, a per-sheet basis setting check box 41, a list name display section 42, a list display section 43, a sheet add button 44, an update button 45, an edit button 46 and a delete button 47 are arranged therein. As shown in FIG. 6, the list name display section 42 can display a plurality of lists, and different per-sheet basis setting can be saved to each displayed list.

The per-sheet basis setting list screen of FIG. 5 shows one example of making a booklet composed of two sheets, where two pages of a document are printed to both sides of the sheet respectively. When the per-sheet basis setting check box 41 of the per-sheet basis setting list screen is checked in FIG. 5, the sheet add button 44 becomes available. When the sheet add button 44 is pushed, the per-sheet basis setting screen as shown in FIG. 7 is displayed.

The per-sheet basis setting screen is to set the print mode on a per-sheet basis. As shown in FIG. 7, a sheet number setting section 51, a page number setting section 52, a paper feed tray setting section 53, a paper type setting section 54, an M weight setting section 55, a paper color setting section 56, an OK button 57 to save a set condition, a cancel button 58 to cancel the set condition are arranged therein. In the per-sheet basis setting screen of FIG. 7, the print mode is set by inputting sheet number to the sheet number setting section 51 or page number to the page number setting section 52 or inputting both of the sheet number and page number, and further inputting necessary information to the other setting section, and pushing an OK button 57.

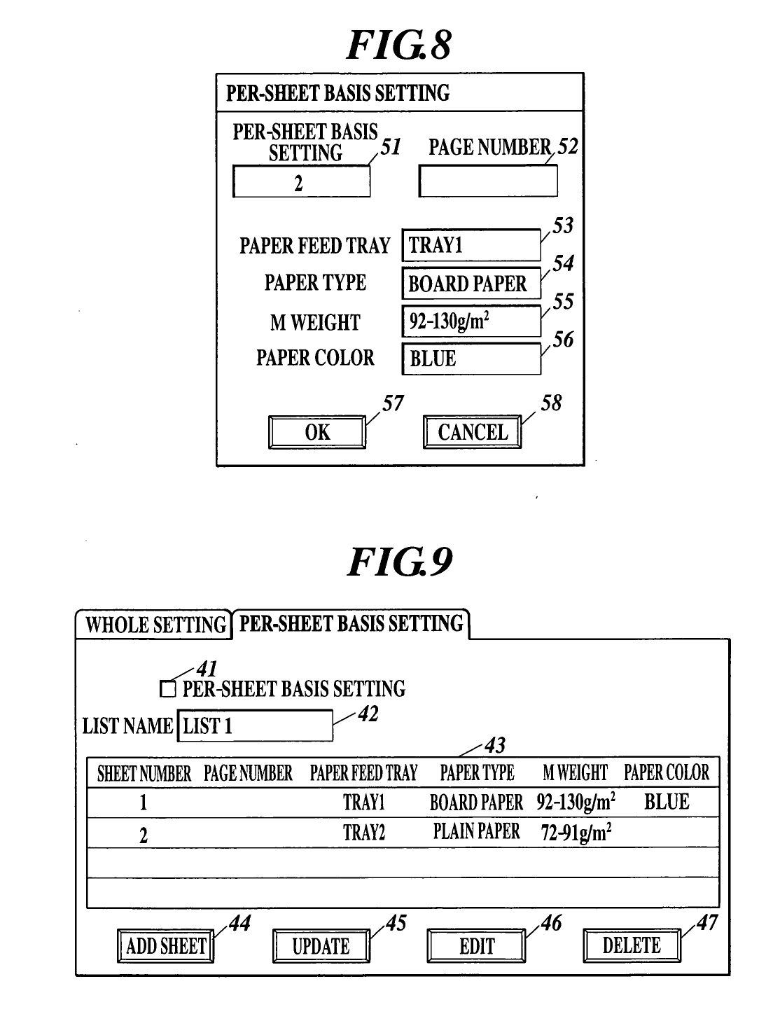

As shown in FIG. 8, for example, the print mode can be set in a condition that page number is not input in the page number setting section 52 but sheet number is input in the sheet number setting section 51 in the per-sheet basis setting screen. In this case, a page number column of the list display section 43 do not display page number in the per-sheet basis setting list screen as shown in FIG. 9. When the updating button 45 is pushed, all page numbers which are arranged to the set sheet are displayed as shown in FIG. 5.

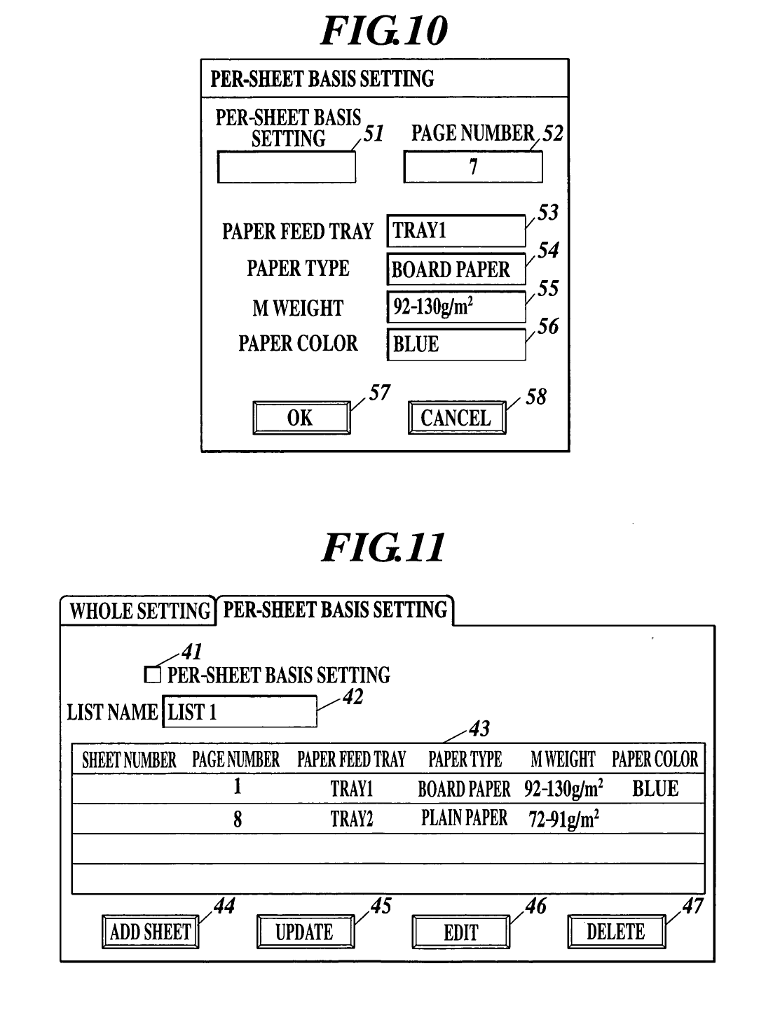

Further, as shown in FIG. 10, the print mode can be set in a condition that sheet number is not input in the sheet number setting section 51 but page number is input in the page number setting section 52 in the per-sheet basis setting screen. In this case, a sheet number column of the list display section 43 do not display sheet number in the per-sheet basis setting list screen as shown in FIG. 9. When the updating button 45 is pushed, sheet number to which the set page are arranged and all the pages arranged to the sheet are displayed as shown in FIG. 5. Thus, when the print mode is set to one page of a plurality of pages arranged to one sheet, the set print mode is also set to the whole sheet.

When the print condition is set in the PC 1, data of the set condition is sent to the printer 2 and a page layout (impositioning) of each sheet are set in the printer 2 (step S2). In step S2, the print condition analyzing section 21 analyzes the received print condition firstly, and the page layout section 22 sets the page layout. (impositioning) so that an output results a book.

For example, when a booklet composed of 8 pages is printed, the impositioning is performed so that pages 1 and 8 of a document are printed to a front side of the first sheet by 2 in 1, pages 2 and 7 are printed to the back side thereof by 2 in 1, pages 3 and 6 are printed to a front side of the second sheet by 2 in 1, and pages 4 and 5 are printed to the back side thereof by 2 in 1.

When a page layout for each sheet is set, it is judged whether per-sheet basis setting is set as the print condition or not (step S3). The per-sheet basis setting is one set with the per-sheet basis setting screen of FIG. 7 and the per-sheet basis setting list screen of FIG. 5.

In step S3, when it is judged that the per-sheet basis setting has not been set (step S3; NO), the print mode which has set in the whole setting screen of FIG. 4 is set to all sheets uniformly (step S4) and the process shifts to step S8. In step S3, when it is judged that the per-sheet basis setting has been set (step S3; YES), the print mode is set on a per-sheet basis according to the print condition which has set in step S1 (step S5).

When the print mode is set on a per-sheet basis, it is judged whether different print modes are set in a plurality of pages in one sheet or not (step S6). In step S6, it is judged that different print modes are set in a plurality of pages in one sheet (step S6; YES), the display section 12 of the PC 1 displays a warning message as shown in FIG. 12 (step S7) and the process returns to step S1 so that the setting process of print condition is performed again.

In step S6, it is judged that different print mode are not set in a plurality of pages in one sheet (step S6; NO), the print data and print mode are set on a per-sheet basis (step S8) and said print data and print mode are output to the image forming member 30 (step S9). Then, the print setting process is terminated.

As described above, according to the print system 100 of the present embodiment, the print mode is set on a per-sheet basis which is to be output in book printing. Thus, even in a case of a book of complex constitution, where different type of sheets are used, it becomes possible to finish the book easily only in one printing process.

In the above embodiment, the print condition analyzing section 21 of the printer 2 judges whether different print modes are set in a plurality of pages in one identical sheet or not. However, the PC 1 may also judge that. That is, in the setting of a print condition of step S1, the print driver may monitor whether different print modes are set in a plurality of pages in one identical sheet or not. At the time different print mode is set, for example, the display section 12 displays the warning message as shown in FIG. 12.

The present application is based on the entire disclosure, including the specification, claims, drawings, and abstract, of Japanese Patent Application No. Tokugan 2005-188145 filed with Japan Patent Office on Jun. 28, 2005.

What is claimed is:

1. A user interface to carry out a book printing in which one sheet is associated with a plurality of pages of a book, the user interface being capable of setting different print modes for the sheets constituting the book.

2. The user interface of claim 1, wherein a display section displays a plurality of page numbers corresponding to pages that are laid out to a same sheet to which at least one of the print modes has been set.

3. The user interface of claim 1, wherein each of the print modes is settable on a per-page basis.

4. The user interface of claim 3, wherein when the print mode is set to any one page of a plurality of pages laid out to one sheet, the set print mode is applied to whole the one sheet.

5. The user interface of claim 3, wherein when different print modes are set to two or more different pages of a plurality of pages laid out to one sheet, the display section displays a warning screen.

6. The user interface of claim 3, wherein when a print mode is set to a page, a display section displays a sheet number of the sheet to which the page is laid out.

7. The user interface of claim 1, wherein the user interface sets the different print mode for the sheets constituting the book if one print job is to print on at least two sheets.

8. A computer readable medium in which a computer program is stored, the computer program causing a computer to carry out a book printing in which one sheet is associated with a plurality of pages of a book, the computer program also causes the computer to present a user interface capable of setting different print modes for the sheets constituting the book.

9. The computer readable medium of claim 8, wherein the computer program further causes the computer to carry out displaying on a display section a plurality of page numbers corresponding to pages that are laid out to a same sheet to which at least one of the print modes has been set.

10. The computer readable medium of claim 8, wherein the computer program further causes the computer to set each of the print modes on a per-page basis.

11. The computer readable medium of claim 10, wherein when the print mode is set to any one page of a plurality of pages laid out to one sheet, the computer program causes the computer to carry out to apply the set print mode to whole the one sheet.

12. The computer readable medium of claim 10, wherein when different print modes are set to two or more different pages of a plurality of pages laid out to one sheet, the computer program causes the computer to display a warning screen.

13. The computer readable medium of claim 10, wherein when a print mode is set to a page, the computer program causes the computer to display a sheet number of the sheet to which the page is laid out.

14. The computer readable medium of claim 8, wherein the computer program causes the computer to set the different print modes for the sheets constituting the book of one print job is to print on at least two sheets.
